(19) United States
(12) Patent Application Publication
(10) Pub. No.: US 2026/0059081 A1
(43) Pub. Date: Feb. 26, 2026

(54) ELECTRONIC APPARATUS AND CONTROL METHOD THEREOF

(71) Applicant: SAMSUNG ELECTRONICS CO., LTD., Suwon-si (KR)

(72) Inventor: Youngjoon YOO, Suwon-si (KR)

(73) Assignee: SAMSUNG ELECTRONICS CO., LTD., Suwon-si (KR)

(21) Appl. No.: 19/283,955

(22) Filed: Jul. 29, 2025

Related U.S. Application Data
(63) Continuation of application No. PCT/KR2025/009370, filed on Jul. 1, 2025.

(30) Foreign Application Priority Data
Aug. 23, 2024 (KR) 10-2024-0113254

(51) Int. Cl. H04N 9/31; G06F 3/01

(52) U.S. Cl. CPC H04N 9/3185; G06F 3/017; H04N 9/3188

(57) ABSTRACT

There is provided an electronic apparatus including a projector, memory storing at least one instruction, and at least one processor. The at least one instruction, when executed by the at least one processor, cause the electronic apparatus receive first position information from an external apparatus, control the projector to project a first image onto a first projection region obtained based on the first position information; receiving second position information different from the first position information while the first image is projected onto the first projection region, obtain a second projection region different from the first projection region based on the second position information; and control the projector to project a second image corresponding to the second position information onto the second projection region.

### CROSS-REFERENCE TO RELATED APPLICATIONS

This application is a continuation of International Application No. PCT/KR2025/009370 designating the United States, filed on Jul. 1, 2025, in the Korean Intellectual Property Receiving Office and claiming priority to Korean Patent Application No. 10-2024-0113254, filed on Aug. 23, 2024, in the Korean Intellectual Property Office, the disclosures of each of which are incorporated by reference herein in their entireties.

### BACKGROUND

### Field

This disclosure relates to an electronic apparatus and a control method thereof, and particularly to, an electronic apparatus for obtaining a projection region based on position information of a user of an external apparatus and a control method thereof.

### Description of Related Art

With the advancement of electronic technologies, various types of electronic apparatus are developed and supplied. For example, advancements in electronic apparatus for performing a video call have been made enabling a plurality of users to make a video call with one another in a variety of places such as their home, their office, public places and the like.

Recently, a video call apparatus producing a 3D effect has been developed in which participants in a video call feel like they are present in the same space.

However, according to a related art 3D augmented reality method using a virtual reality (VR) equipment, there is a problem that participants need to wear VR equipment, which may be bulky and/or heavy. In another method using a plurality of sensors and output apparatus on the ceiling and the like of an indoor space, there is a problem such as a limited sensing range of the sensors, a limited output range of the output apparatus and complex installation processes of the sensors and the output apparatus.

Thus, there is a growing demand for a technology that enables a readily movable apparatus to share a position of a user with another user in real time while the apparatus follows the user, without equipment worn by the user.

### SUMMARY

According to an aspect of the disclosure, there is provided an electronic apparatus including: a projector; memory configured to store at least one instruction; a communicator; and at least one processor connected to the projector, the communicator and the memory, wherein, when executed by the at least one processor, the at least one instruction is configured to: receive first position information from an external apparatus through the communicator, control the projector to project a first image onto a first projection region obtained based on the first position information; receiving second position information different from the first position information through the communicator while the first image is projected onto the first projection region, obtain a second projection region different from the first projection region based on the second position information; and control the projector to project a second image corresponding to the second position information onto the second projection region.

The electronic apparatus may further include a driver configured to adjust a projection direction of the electronic apparatus; and a mover configured to move the electronic apparatus, wherein, when executed by the at least one processor, the at least one instruction may be further configured to control at least one of the driver and the mover such that the projector projects the second image onto the obtained second projection region.

The first position information may include a first position of a counterpart corresponding to the external apparatus in an external space in which the external apparatus is placed, and the second position information may include a second position to which the counterpart moves from the first position.

The first image may be an image of the counterpart positioned in the first position, the first image being captured by the external apparatus, and when executed by the at least one processor, the at least one instruction may be further configured to control the projector to project the second image corresponding to an image of the counterpart positioned in the second position onto the second projection region, the second image being captured by the external apparatus.

The first image may be obtained based on a distance between a region onto which a third image different from the first image and the second image is projected and the first position, and the second image may be obtained based on a distance between a region onto which a fourth image different from the first image and the second image is projected and the second position.

The first image may be obtained further based on a distance between a user of the electronic apparatus and a position of the first projection region, and the second image may be obtained further based on a distance between the user of the electronic apparatus and a position of the second projection region.

The electronic apparatus may further include: at least one sensor, wherein the memory stores map information corresponding to a space in which the electronic apparatus is placed, and wherein, when executed by the at least one processor, the at least one instruction may be further configured to: obtain a moving path for reaching a position for projecting the second image onto the second projection region, based on the map information, the first projection region and the second projection region, and based on identifying an object within a threshold distance from the electronic apparatus through the at least one sensor while the electronic apparatus moves along the moving path, obtain an updated moving path based on the object and the moving path and control the mover to move along the updated moving path such that the projector projects the second image onto the second projection region.

The at least one instruction, when executed by the at least one processor, may be further configured to: obtain a plurality of projection regions based on sensing data obtained from the at least one sensor; control the projector to project the first image onto the first projection region included in the plurality of projection regions; and obtain the second projection region included in the plurality of projection regions.

The at least one instruction, when executed by the at least one processor, may be further configured to: adjust a size of the first projection region based on a surface area of each of a first projection surface occupied by the plurality of projection regions and a second projection surface corresponding to an external space in which the external apparatus is placed; and adjust a size of the second projection region based on the surface area of each of the first projection surface and the second projection surface.

The memory may store a software model configured to predict a current position of the counterpart corresponding to the second position, based on the first position and the second position, and wherein, when executed by the at least one processor, the at least one instruction may be further configured to: obtain a current position of the counterpart through the software model, based on the second position information; and obtain the second projection region corresponding to the obtained current position of the counterpart.

According to another aspect of the disclosure, there is provided a control method of an electronic apparatus, the method including: receiving first position information obtained by an external apparatus; projecting a first image onto a first projection region obtained based on the first position information; receiving second position information different from the first position information while the first image is projected onto the first projection region; obtaining a second projection region different from the first projection region based on the second position information; and projecting a second image onto the second projection region.

The method may further include adjusting, by a driver, a projection direction of the electronic apparatus; moving, by a mover, the electronic apparatus, and controlling at least one of the driver and the mover to project the second image onto the second projection region.

The first position information may include a first position of a counterpart corresponding to the external apparatus in an external space in which the external apparatus is placed, and the second position information may include a second position to which the counterpart moves from the first position.

The first image may be an image of the counterpart positioned in the first position, the first image being captured by the external apparatus, and the projecting the second image may include projecting the second image corresponding to an image of the counterpart positioned in the second position onto the obtained second projection region, the second image being captured by the external apparatus.

The first image may be obtained an based on a distance between a region onto which a third image different from the first image and the second image is projected and the first position, and the second image may be obtained based on a distance between a region onto which a fourth image different from the first image and the second image is projected and the second position.

### BRIEF DESCRIPTION OF THE DRAWINGS

FIG. 1 is a view provided to explain operations of an electronic apparatus and an external apparatus, according to one or more embodiments;

FIG. 2 is a block diagram provided to explain a configuration of an electronic apparatus, according to one or more embodiments;

FIG. 3 is a detailed block diagram provided to explain a detailed configuration of an electronic apparatus, according to one or more embodiments;

FIG. 4 is a view provided to explain an operation of an electronic apparatus, according to one or more embodiments;

FIG. 5 is a view provided to explain first position information and second position information, according to one or more embodiments;

FIG. 6A is a view provided to explain an operation of obtaining position information, according to one or more embodiments;

FIG. 6B is a view provided to explain an operation of obtaining position information, according to one or more embodiments;

FIG. 6C is a view provided to explain an operation of obtaining position information, according to one or more embodiments;

FIG. 7 is a view provided to explain an operation of capturing an image based on a distance, according to one or more embodiments;

FIG. 8A is a view provided to explain a moving path, according to one or more embodiments;

FIG. 8B is a view provided to explain a moving path, according to one or more embodiments;

FIG. 9 is a view provided to explain a movement region of an electronic apparatus, according to one or more embodiments;

FIG. 10 is a view provided to explain a projection region, according to one or more embodiments; and

FIG. 11 is a flowchart provided to explain a control method of a plurality of display apparatus and a communicable electronic apparatus, according to one or more embodiments.

### DETAILED DESCRIPTION

Embodiments of the disclosure may be modified in various different forms, and there may be various embodiments. Accordingly, specific embodiments are illustrated in drawings, and described in detail in the detailed description. However, it is to be understood that the various embodiments are not intended to limit the scope of the disclosure to a specific embodiment but they are to be interpreted as including various modifications, equivalents and/or alternatives of the embodiments set forth herein. In the drawings, like reference numerals may be used to indicate like elements.

In describing embodiments of the disclosure, in case specific descriptions of known functions or configurations to which the disclosure pertains make the gist of the disclosure unnecessarily vague, detailed descriptions thereof are omitted.

Additionally, the embodiments hereinafter may be modified in various different forms, and it is to be understood that the scope of the technical spirit of the disclosure is not limited to the embodiments hereinafter. Rather, the embodiments are provided to make the disclosure thorough and complete and to fully convey the technical spirit of the disclosure to one skilled in the art.

Terms as used herein are merely used to describe a specific embodiment, and are not intended to limit the scope of the right seeking protection. Unless explicitly stated otherwise, singular forms include plural forms as well.

In the disclosure, expressions such as “have,” “may have,” “include,” or “may include,” and the like are used to indicate the presence of a corresponding feature (e.g., elements such as a numerical value, a function, an operation, or a component and the like), and not exclude the presence of additional features.

In the disclosure, expressions such as “A or B,” “at least one of A and/or B,” or “one or more of A and/or B” may include all possible combinations of items listed together. For example, “A or B,” “at least one of A and B,” or “at least one of A or B” may refer to all cases including (1) at least one A, (2) at least one B, or (3) both of at least one A and at least one B.

In the disclosure, the expression “1st”, “2nd”, “first”, or “second”, and the like may be used to refer to various elements regardless of their order and/or importance, and may be used merely to differentiate one element from another but not be intended to limit the elements.

Based on one element (e.g., a first element) referred to as being “(operatively or communicatively) coupled with/to or connected with/to” another element (e.g., a second element), it is to be understood that one element may connect to another element directly, or through yet another element (e.g., a third element).

On the other hand, based on one element (e.g., a first element) referred to as being “directly coupled with/to” or “directly connected with/to” another element (e.g., a second element), it is to be understood that yet another element (e.g., a third element) is not present between one element and another element.

In the disclosure, the expression “configured to . . . (or set to)” used in the disclosure may be used interchangeably with, for example, “suitable for . . . ,” “having the capacity to . . . ,” “designed to . . . ,” “adapted to . . . ,” “made to . . . ,” or “capable of . . . ” depending on circumstances. The term “configured to . . . (or set to)” may not necessarily mean “being specifically designed to” in terms of hardware.

Rather, in a certain situation, the expression “an apparatus configured to . . . ” may mean being capable of performing by the apparatus together with another apparatus or component. For example, the phrase “a processor configured (or set) to perform A, B and C may mean an exclusive processor (e.g., an embedded processor) for performing the functions or a generic-purpose processor (e.g., a CPU or an application processor) capable of performing the functions by executing one or more software programs stored in a memory apparatus.

In relation to the embodiments, the term “module” or “unit” may perform at least one function or operation, and be implemented by hardware or software or by a combination of hardware and software. In addition, a plurality of “modules” or a plurality of “units” may be integrated into at least one module and be implemented as at least one processor except for a “module” or a “unit” that needs to be implemented by specific hardware. The term “module” or “part” used in one or more embodiments herein perform at least one function or operation, and may be implemented with a hardware or software, or implemented with a combination of hardware and software. In addition, a plurality of “modules” or a plurality of “parts,” except for a “module” or a “part” which needs to be implemented to a specific hardware, may be integrated to at least one module and implemented in at least one processor.

Operations performed by a module, a program, or another element, according to various embodiments, may be performed sequentially, in parallel, repetitively, or heuristically, or at least part of the operations may be performed in a different order, may be omitted, or may add a different operation.

According to an embodiment, various elements and regions in the drawings are schematically illustrated. Accordingly, the technical spirit of the disclosure is not limited by relative sizes or distances illustrated in the accompanying drawings.

According to an embodiment, an electronic apparatus, according to various embodiments, may include, but is not limited to, at least one of a smartphone, a tablet PC, a desktop PC, a laptop PC, or a wearable apparatus, for example. The wearable apparatus may include, but is not limited to, at least one of an accessory-type wearable apparatus (e.g., a watch, a ring, a bracelet, an ankle bracelet, a necklace, glasses, contact lenses or a head-mounted-apparatus (HMD)), a fabric or cloth-integrated wearable apparatus (e.g., electronic cloth), a body-attachable wearable apparatus (e.g., a skin pad or tattoo), or implantable circuitry.

In some embodiments, an electronic apparatus (or external apparatus), for example, may include, but is not limited to, at least one of a television, a digital video disk (DVD) player, an audio, a refrigerator, an air conditioner, a vacuum cleaner, an oven, a microwave oven, a washing machine, an air purifier, a set-top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, or an electronic picture frame. According to an embodiment, among the above-described electronic apparatus, an apparatus provided with a display may be referred to as a display apparatus. According to an embodiment, an electronic apparatus according to the disclosure may be a set-top box or a PC that provides an image to a display apparatus, although the electronic apparatus is not provided with a display apparatus.

Hereinafter, embodiments of the disclosure are described in detail with reference to the accompanying drawings such that one having ordinary skill in the art may readily implement the embodiments set forth herein.

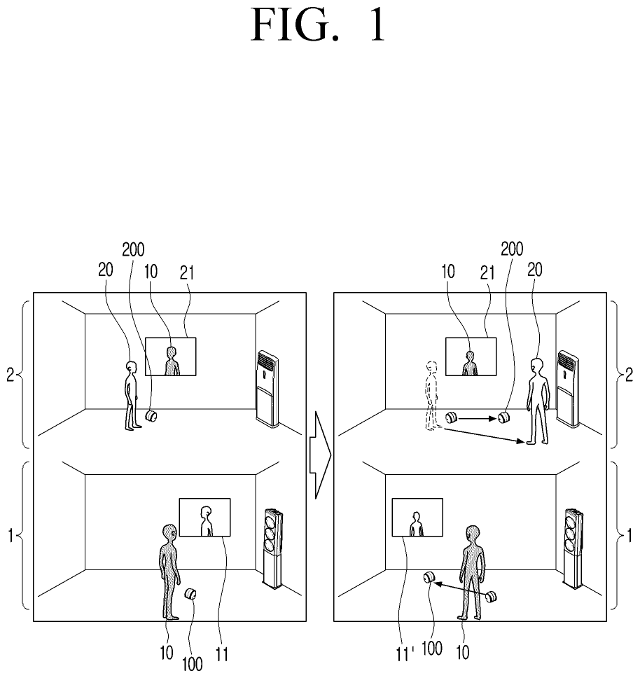

FIG. 1 is a view provided to explain operations of an electronic apparatus and an external apparatus, according to one or more embodiments.

According to FIG. 1, a user 10 and a counterpart 20 may respectively perform a video call through the electronic apparatus 100 and the external apparatus 200. Here, the counterpart 20 may be another user performing the video call with the user 10. The user 10 may be located in a first space 1 and the counterpart 20 may be located in a second space 2. The user 10 and the counterpart 20 may perform the video call, through a first image projected in a first projection region in the first space 1 and a second image projected in a second projection region 21 the second space. For example, the counterpart 20 may change a position in the second space 2.

For example, the user 10 positioned in the first space 1 may see the appearance of the counterpart 20 through a projection image 11 projected by the electronic apparatus 100, and the counterpart 20 positioned in the second space 2 may see the appearance of the user 10 through a projection region 21 onto which the external apparatus 200 projects an image. In an example case where the position of the counterpart 20 is moved, the external apparatus 200 may move in accordance with the position of the counterpart 20. According to an embodiment, the electronic apparatus 100 may move based on the movement of the position of the counterpart 20 in the second space 2, change the projection region in the first space 1, and project an image containing the appearance of the counterpart 20 onto a changed projection region 11′.

An example case in which the user 10 does not move in the first space 1, while the counterpart 20 moves in the second space 2, is described above with reference to FIG. 1. However, the disclosure is not limited thereto, and as such, according to other example cases, the counterpart 20 does not move while the user 10 moves in the first space 1, or both the user 10 and the counterpart 20 may move in the first space 1 and the second space 2 respectively. For example, in the case where the user 10 only moves, the projection region 21 in the second space 2 may be changed. In the case where both the user 10 and the counterpart 20 move, both the projection region 11 in the first space 1 and the projection region 21 in the second space 2 may be changed respectively based on the movement of the counterpart 20 and the user 10.

According to an embodiment, the electronic apparatus 100 and the external apparatus 200 may respectively correspond to a projector capable of projecting each image in the first space 1 and the second space 2. For example, the projector may denote an apparatus that projects an image on a surface, such as, a wall or a screen. FIG. 1 illustrates the electronic apparatus 100 and the external apparatus 200 as a projector of an identical form, but the disclosure is not limited thereto, and as such, the electronic apparatus 100 and the external apparatus 200 may be implemented in a different form. The electronic apparatus 100 and the external apparatus 200 may also be implemented in various different forms without being limited to a projector, as long as the electronic apparatus 100 and the external apparatus 200 have an image projecting function. For example, the electronic apparatus 100 may be referred to as “the user's electronic apparatus”, “the electronic apparatus of the user” and “first electronic apparatus”, and the external apparatus 200 may be referred to as “the counterpart's electronic apparatus”, “the electronic apparatus of the counterpart” and “second electronic apparatus”, but for convenience of description, the apparatuses are referred to as an electronic apparatus 100 and an external apparatus 200 respectively.

According to an embodiment, the user 10 may perform a video call with the counterpart 20, in the first space 1, by using the electronic apparatus 100. The counterpart 20 may perform a video call with the user 10, in the second space 2, by using the external apparatus 200. Herein, the user 10 and the counterpart 20 may be referred to as “first user” and “second user” respectively. However, According to one or more embodiments in this disclosure, for convenience of description, they are referred to as a user 10 and a counterpart 20.

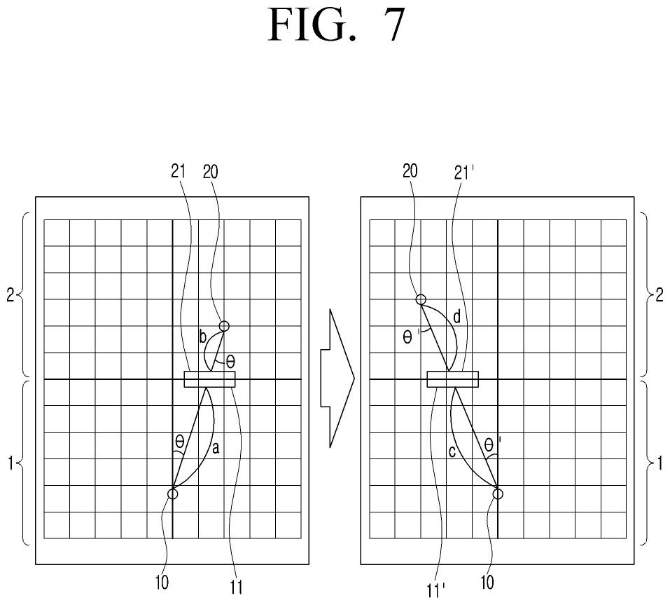

According to an embodiment, the image containing the appearance of the user 10 and the image containing the appearance of the counterpart 20 may be images that respectively correspond to images captured by the electronic apparatus 100 and the external apparatus 200. Detailed descriptions in relation to this are provided hereinafter with reference to FIG. 7.

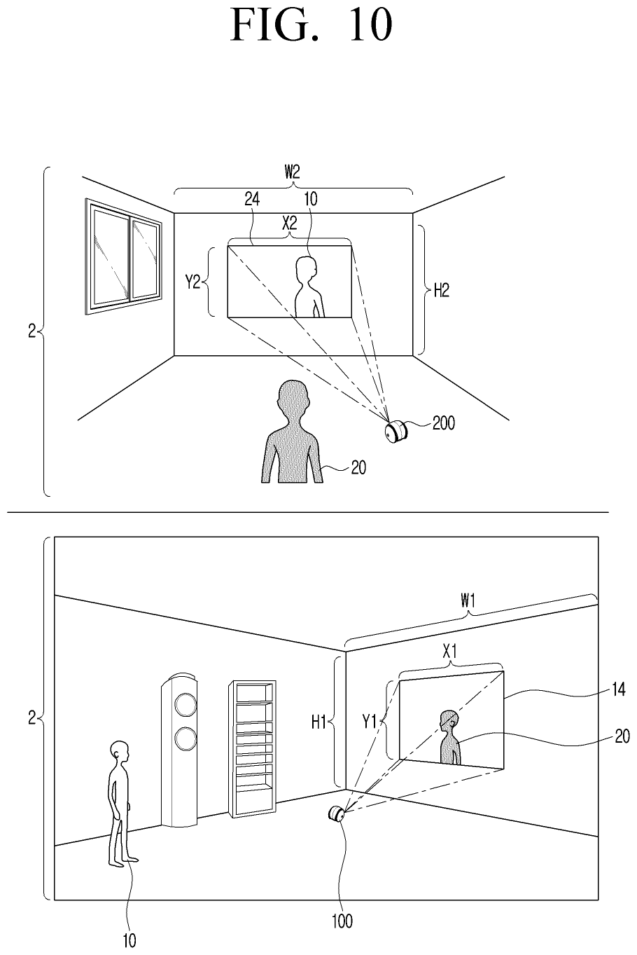

According to an embodiment, the first space 1 and the second space 2 may respectively denote a space where the user and the counterpart is positioned, and include at least one projectable region. According to one or more embodiments in this disclosure, the first space 1 may be referred to as “the user's space” or “the space the user”, and the second space 2 may be referred to as “the counterpart's space”, “the space of the counterpart” or “an external space”. For example, at least one projectable region in each of the first space 1 and the second space 2 may differ. According to an embodiment, the electronic apparatus 100 and the external apparatus 200 may adjust a size of the projection region 11, 21 based on a difference of the projectable regions. Detailed descriptions in relation to this are provided hereinafter with reference to FIG. 10.

As described above, the images of the counterpart 20 and the user 10 may be projected onto the projection regions 11, 21 based on the position and movement of the user 10 and the counterpart 20. An operation of identifying the projection regions 11, 21 and an operation of projecting an image may also be performed by the electronic apparatus 100 and the external apparatus 200. The whole operation of the electronic apparatus 100 of this disclosure may be performed by the external apparatus 200 in the same way, and hereinafter, operations of the electronic apparatus 100 are described in detail.

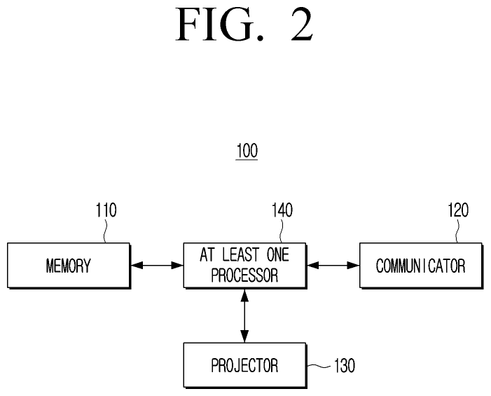

FIG. 2 is a block diagram provided to explain a configuration of an electronic apparatus, according to one or more embodiments.

Referring to FIG. 2, the electronic apparatus 100 may include memory 110, a communicator 120, a projector 130, and at least one processor 140.

The memory 110 may store data required for various embodiments. The memory 110 may be implemented in the form of memory embedded in the electronic apparatus 100, or in the form of memory detachable from the electronic apparatus 100 depending on a data storage purpose.

For example, data for driving the electronic apparatus 100 may be stored in the memory embedded in the electronic apparatus 100, and data for an expansion function of the electronic apparatus 100 may be stored in memory detachable from the electronic apparatus 100.

The memory embedded in the electronic apparatus 100 may be implemented in the form of at least one of volatile memory (e.g., dynamic RAM (DRAM), static RAM (SRAM) or synchronous dynamic RAM (SDRAM), and the like) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, or solid state drive (SSD)).

Additionally, the memory detachable from the electronic apparatus 100 may be implemented in the form of a memory card (e.g., a compact flash (CF), a secure digital (SD), a micro secure digital (Micro-SD), a mini secure digital (Mini-SD), an extreme digital (xD), a multi-media card (MMC), and the like), external memory connectable to a USB port (e.g., USB memory), or the like.

The memory 110, according to one or more embodiments, may include various types of instructions required for an operation of the processor 140. For example, the instructions may include, but is not limited to, an instruction for identifying a projection region where projection is possible in a surrounding environment, an instruction for projecting an image based on received position information, an instruction for processing a change in the projection region, an instruction for moving the electronic apparatus 100 based a change in the position of the projection region or the user 10, an instruction for correcting keystone, an instruction for recognizing or processing a user voice, an instruction for processing an image, and the like.

The memory 110, according to one or more embodiments, may store at least one software model. For example, the memory 110 may store a software model for predicting a current position of the counterpart. The electronic apparatus 100 may obtain current position information of the counterpart through the software model, and based on the obtained current position information, identify the projection region.

The communicator 120 is an element that performs communication with various types of external apparatuses based on various types of communication methods. The communicator 120 may include, but is not limited to, a WiFi® module, a Bluetooth® module, an infrared communication module, a wireless communication module and the like. For example, each of the communication modules may be implemented in the form of at least one hardware chip.

The WiFi module and the Bluetooth module may perform communication based on a WiFi method and a Bluetooth method respectively. In the case where the WiFi module or the Bluetooth module is used, various types of connection information such as a SSID, a session key and the like may be first transmitted and received, and are used to perform communication connection and then transmit and receive various types of information.

The infrared communication module performs communication based on an infrared Data Association (IrDA) communication technology which transmits data wirelessly over a short distance using infrared rays between optical light and millimeter waves.

In addition to the above-described communication methods, the wireless communication module may include at least one communication chip that performs communication according to various wireless communication standards such as Zigbee, 3rd Generation (3G), 3rd Generation Partnership Project (3GPP), Long Term Evolution (LTE), LTE Advanced (LTE-A), 4th Generation (4G), 5th Generation (5G) and the like.

Other communicators 120 include at least one of wired communication modules that perform communication by using a local region network (LAN) module, an Ethernet module, pair cables, coaxial cables, fiber optic cables, or an Ultra Wide-Band (UWB) module, and the like. The communicator 120 may also be referred to as a transceiver.

According to an embodiment, the electronic apparatus 100 may receive a signal requesting information on a projection region in the space where the electronic apparatus 100 is placed from a server and the like, through the communicator 120. According to an embodiment, the electronic apparatus 100 may transmit a signal requesting information on a projection region of the space where the electronic apparatus 100 is placed to a server and the like through the communicator 120. According to an embodiment, the electronic apparatus 100 may identify a position appropriate for the electronic apparatus 100 to project an image onto a projection region, based on the received information on a projection region, and move to the identified position and project an image to the projection region.

According to an embodiment, the electronic apparatus 100 may receive, from a server apparatus and the like, the information on a projection region and a control signal to move to a position for projecting an image onto the region and to project the image. The electronic apparatus 100 may move to a position for projecting an image onto the projection region based on the received control signal, and project an image onto the projection region.

According to an embodiment, the electronic apparatus 100 may further include an interface such as a HDMI port, a DP, a RGB, a DVI, a USB, a Thunderbolt, and the like for connecting with external apparatuses or servers and receiving a video/audio signal. The HMDI, DP, and Thunderbolt are ports capable of transmitting a video signal and an audio signal at the same time. The electric apparatus 100 may identify a projection region or output an image to the identified projection region by performing various types of processing such as demuxing, decoding, scaling and the like with respect to various signals received from an external apparatus and a server and the like that perform communication with an external apparatus through the communicator 120 and such various interfaces.

According to one or more embodiments, the electronic apparatus 100 may receive an image or position information through the communicator 120, and may transmit the image or position information obtained by the electronic apparatus 100 to a server performing communication with an external apparatus or an external apparatus.

According to an embodiment, the projector 130 may project an image. The projector 130 may project an image onto a projection region by using a light source such as a lamp or an LED, but the disclosure is not limited thereto. For example, the projector 130 may project light corresponding to an image through a lens and/or mirror. Accordingly, the projected light may form an image on the projection region.

According to an embodiment, the projector 130 may include, but is not limited to, an ultra-short focus projector, a projection-type projector, or a hybrid-type projector in which an ultra-short focus method and a projection method are transformable. For example, in the case of a hybrid-type projector, a plurality of lenses (e.g., an ultra-short focus lens, a projection-type lens) is provided in the projector 130, and an image is projectable by using a lens corresponding to a change in a projection method.

According to an embodiment, the projector 130 may adjust a light amount projected based on a distance between projection regions and a surrounding environment. In an example case in which a surrounding environment is bright, the projector 130 may project an image with a high light amount (e.g., higher than a reference amount). In another example case in which a surrounding environment is dark, the projector 130 may project an image with a relatively low light amount (e.g., lower than a reference amount). However, the disclosure is not limited thereto, as such, the amount of light projected by the projector 130 may be proportional to the light in the surrounding environment (e.g., the light projected by the projector 130 may be adaptively adjusted).

According to an embodiment, the projector 130 may project an image with a high light amount in the case where the projector operates based on the ultra-short focus method since a distance between a projection region and the electronic apparatus 100 is short. According to an embodiment, the projector 130 may output an image with a low light amount in the case where the projector 130 operates based on the projection-type method because of a relatively long distance.

The above-described operations are described only as examples, the light amount may be calculated considering a surrounding environment, a distance, a surface area of a projection region and the like, and the projector 130 may perform projection of an image based on the calculated light amount.

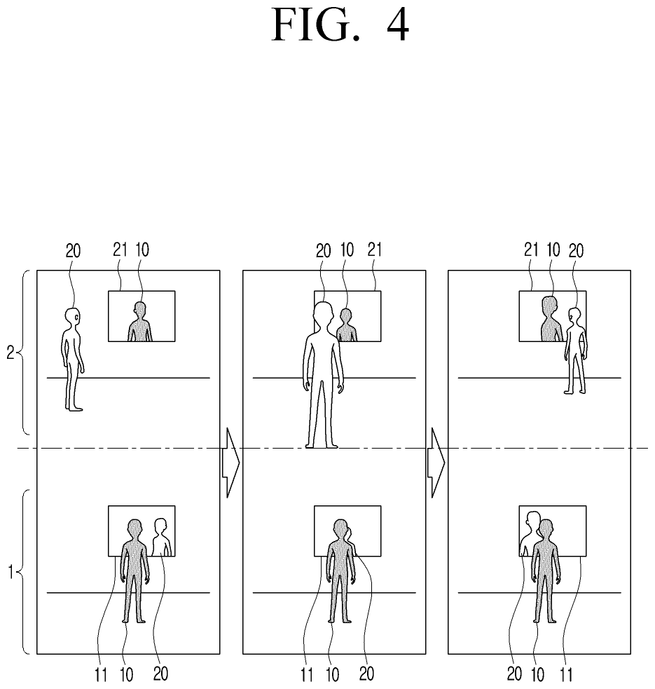

The projector 130, according to one or more embodiments, may project a first image or a second image onto the identified projection region. Hereinafter, a region onto which the first image and the second image are projected is described in detail with reference to FIG. 4 and below.

The at least one processor 140 may perform an entire control operation of the electronic apparatus 100. For example, the at least one processor 140 performs a function of controlling an entire operation of the electronic apparatus 100. However, the disclosure is not limited thereto, and as such, the at least one processor 140 may perform one or more operations of the electronic apparatus 100.

According to an embodiment, the at least one processor 140 may be implemented as a digital signal processor (DSP) processing digital signals, a microprocessor, or a time controller (TCON). However, the at least one processor 140 may not be limited thereto, and may include one or more of a central processing unit (CPU), a micro controller unit (MCU), a micro processing unit (MPU), a controller, an application processor (AP), a graphics-processing unit (GPU) or a communication processor (CP), or an ARM processor, or may be defined as a corresponding term. Additionally, the at least one processor 140 may be implemented in the form of a system on chip (SoC) with embedded processing algorithms, a large scale integration (LSI), or in the form of a field programmable gate array (FPGA). The at least one processor 140 may perform a variety of functions by executing computer executable instructions stored in the memory. According to an embodiment, FIG. 2 shows that only one processor is include in the electronic apparatus 100, but the disclosure is not limited thereto, and as such, according to another embodiment, a plurality of processors (e.g., CPU+GPU, CPU+DSP) may be included in the electronic apparatus 100.

According to one or more embodiments, the at least one processor 140 may be connected to the memory 110, the communicator 120, and the projector 130 and may control the electronic apparatus 100 as follows.

According to one or more embodiments, the at least one processor 140 may control the projector 130 to project a first image onto a first projection region that is obtained based on first position information received from the external apparatus 200 through the communicator 120.

In an example case in which second position information different from the first position information is received from the communicator 120 while the image is projected onto the first projection region, the at least one processor 140 may obtain a second projection region different from the first projection region, based on the second position information.

According to an embodiment, the first position information may include a first position of the counterpart and the second position information may include a second position of the counterpart. For example, a first image and a second image may respectively be images of the counterpart, which are captured by the external apparatus in the first position and the second position. For example, the first image may be an image captured by the external apparatus based on the first position of the counterpart and the second image may be an image captured by the external apparatus based on the first position of the counterpart. Detailed descriptions in relation to this are provided with reference to FIG. 7.

According to one or more embodiments, the at least one processor 140 may control the projector 130 to project the second image corresponding to the second position information onto the second projection region obtained.

According to one or more embodiments, based on sensing data obtained from at least one sensor, the at least one processor 140 may obtain a plurality of projection regions for the electronic apparatus 100 to project an image, control the projector 130 to project a first image onto a first projection region included in the plurality of projection regions, and obtain a second projection region included in the plurality of projection regions. According to an embodiment, based on a surface area of each of a first projection surface occupied by the plurality of projection regions and a second projection surface corresponding to an external space in which the external apparatus 200 is placed, the at least one processor 140 may control the projector 130 to project the first image by adjusting a size of the first projection region, and obtain a second projection region of a size adjusted based on the surface area of each of the first projection surface and the second projection surface. Detailed descriptions in relation to this are provided hereinafter with reference to FIG. 10.

According to one or more embodiments, based on the received second position information, the at least one processor 140 may obtain a current position of the counterpart through a software model, and obtain a second projection region corresponding to the obtained current position of the counterpart.

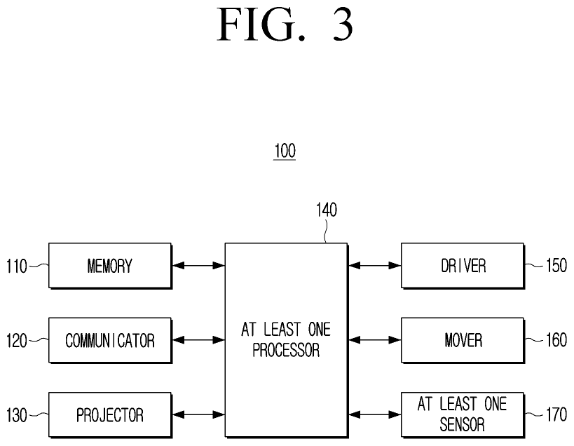

According to an embodiment, FIG. 2 shows an example in which the electronic apparatus 100 includes basic elements (i.e., memory, a processor, a communicator, a projector) only, but the disclosure is not limited thereto, and as such, the electronic apparatus 100 may further include various elements in addition to the above-described elements. Examples in relation to this are described hereinafter with reference to FIG. 3.

FIG. 3 is a detailed block diagram provided to explain a detailed configuration of an electronic apparatus, according to one or more embodiments.

Referring to FIG. 3, an electronic apparatus 100 may include memory 110, a communicator 120, a projector 130, at least one processor 140, a driver 150, a mover 160, and at least one sensor 170.

The memory 110, the communicator 120, the projector 130, and the at least one processor 140 may be same or similar to the components described above with reference to FIG. 2, and accordingly, repetitive description is avoided.

The driver 150 may adjust a projection direction of the projector 130. The driver 150 may be implemented in various different ways. For example, as illustrated in FIG. 1, in the case where the driver 150 is fixed to the projector 130 at the body of the electronic apparatus 100, the driver 150 may adjust the projection direction of the projector 130 by adjusting a direction in which the body faces.

The driver 150 may also adjust the projection direction of the projector 150 by changing a direction of a mirror (or lens) in the projector 130. According to an embodiment, both of the above-described methods may be adopted. For example, the driver 150 may also be implemented, in a way that a predetermined angle is changed by adjusting a direction of the body, and in a way that an additional angle is changed based on the direction of the mirror (or lens).

According to an embodiment, the projector 130 and the driver 150 are described above as a separate element, but in the case where the driver 150 changes the projection direction by adjusting the direction of the mirror (or lens) in the projector 130, the projector 130 and the driver 150 may be implemented as one apparatus. Additionally, the driver 150 may be an element that is integrated with the mover 160 described hereinafter in relation to FIG. 3.

According to one or more embodiments, the at least one processor 140 may control the driver 150 such that the projector 130 projects an image onto an obtained projection region. For example, the at least one processor 140 may control the projector 130 such that the projector 130 may adjust the projection direction, thereby projecting an image onto a projection region different from an existing projection region.

According to an embodiment, the mover 160 may be an element or a component for moving the electronic apparatus 100. For example, the mover 160 may include, but is not limited to, a motor, a wheel and the like. According to an embodiment, the mover 160 may move the electronic apparatus 100 based on the movement of the wheel. According to an embodiment, the mover 160 may include, but is not limited to, a caterpillar and the like may be used instead of the wheel. In an example case in which the electronic apparatus 100 is implemented as a drone and the like, a propeller and the like may be used instead of the wheel.

For example, during a process of determining a projection region, the at least one processor 140 may rotate or move the electronic apparatus 100 by controlling the mover 160, to entirely scan a surrounding space in which the electronic apparatus 100 is placed. For example, the at least one processor 140 may identify a projection region corresponding to the position of the counterpart, in a determined projection region, and move the electronic apparatus 100 by controlling the mover 160 to project an image onto the identified projection region.

According to one or more embodiments, the at least one processor 140 may control at least one of the driver 150 and the mover 160 to project an image onto the obtained projection region. In an example case in which a new projection region changed from the existing projection region is obtained, the at least one processor 140 may control the driver 150 only such that the projector 130 may project an image onto the new projection region, in the case where the projection direction is changeable by controlling the driver 150 only to project the image onto the new projection region. According to an embodiment, the at least one processor 140 may control the mover 160 only, such that the projector 130 may project an image onto the new projection region, with the projection direction fixed to project the image onto the new projection region. Additionally, the at least one processor 140 may control the mover 160 to move the electronic apparatus 100, and control the driver 150 to adjust the projection direction to the new region, such that the projector 130 may project an image onto the new region.

However, the configuration of the mover 160 is only part of various embodiments, and as such, according to another embodiment, the electronic apparatus 100 may not include the mover 160. For example, the electronic apparatus 100 may be a movable projector provided with the mover 160 directly, or a movable projector that needs to be carried directly by the user without the mover 160.

According to an embodiment, the at least one sensor 170 may be a sensor for recognizing a surrounding environment of an electronic apparatus. For example, the at least one sensor 170 may include but is not limited to, at least one of a camera, a time of flight (ToF) sensor and a microphone.

According to an embodiment, the camera may be an apparatus capable of capturing a still image or a moving image. For example, the camera may include, but is not limited to, one or more image sensors (e.g., a front sensor or rear sensor), a lens, an image signal processor (ISP), a flash (e.g., an LED, a Xenon lamp and the like).

The camera, according to one or more embodiments, may capture an image of any object under the control of the at least one processor 140, and deliver the captured data to the at least one processor 140. For example, the electronic apparatus 100 may use two or more cameras rather than one camera. Certainly, the captured data may be stored in the memory 110 under the control of the at least one processor 140. For example, the captured data may be referred to as a picture, an image, a still image, a moving image and the like in various ways, but hereinafter, for convenience of description, is collectively referred to as an image. According to an embodiment, the image, according to various embodiments, may certainly denote an image received from an external server and the like, an image stored in the memory 110, and the like as well as a live view image captured through a camera.

For example, the at least one processor 140 may control the camera to entirely capture an image of a surrounding space in which the electronic apparatus 100 is placed during a process of determining a plurality of projection regions. For example, the surrounding space may denote a space including a plurality of projectable regions, and a range of a region in which the electronic apparatus 100 is movable.

According to an embodiment, the TOF sensor may be a three-dimensional sensor that calculates a distance at which light emitted to an object through infrared wavelengths reflects from the object as time and recognizes a stereoscopic effect of the object or space information.

The ToF sensor obtains light (hereinafter, reflective light) reflected by an object of a surrounding space of the electronic apparatus 100. For example, the ToF sensor receives reflective light that reflects from an object and travels back toward the ToF sensor after light is output from a light emitter.

The ToF sensor may be implemented as an indirect ToF (iToF). The iToF sensor may obtain a phase difference after identifying a difference between a phase of received reflective light and a phase of output light output from the light emitter. According to an embodiment, the ToF sensor may also be implemented as a direct ToF sensor (dToF). The dToF sensor may obtain a difference value ToF between time when light is output and time when light reflected by an object is received. The at least one processor 140 may obtain a distance between the ToF sensor and the object based on the obtained phase difference or time difference value.

For example, the at least one processor 140 may identify the position of the projection region of the surrounding space of the electronic apparatus 100 and the position of the object based on sensing data obtained by the ToF sensor.

According to an embodiment, the microphone may receive a user voice in an activated state. For example, the microphone may be integrally formed in the directions of the upper side or the front surface, lateral surface and the like of the electronic apparatus 100. The microphone may include various types of elements such as a microphone collecting a user voice in an analogue form, amp circuitry amplifying the user voice collected, A/D conversion circuitry sampling the user voice amplified and converting the same into a digital signal, and filter circuitry removing a noise component from the digital signal converted, and the like.

According to an embodiment, the microphone may transmit the received user voice to the electronic apparatus 100. Then the electronic apparatus 100 may perform a voice recognition by inputting the received user voice to a voice recognition model. For example, the electronic apparatus 100 may perform a voice recognition of the user voice, by performing speech to text (STT) on the user voice. The microphone may receive a user voice, and transmit the received user voice to the electronic apparatus 100. Then the electronic apparatus 100 may perform the voice recognition by inputting the received user voice to the voice recognition model. For example, the electronic apparatus 100 may perform a voice recognition of the user voice, by performing speech to text (STT) on the user voice.

According to an embodiment, the at least one processor 140 may sense a movement of a user positioned around the electronic apparatus 100 based on a voice signal received through the microphone.

According to one or more embodiments, the at least one processor 140 may control the at least one sensor 170 to sense a surrounding space of the electronic apparatus 100. Based on sensing data (e.g., a RGB image, a ToF, a voice signal and the like) sensed by the at least one sensor 170, the at least one processor 140 may identify a plurality of projectable regions, and based on received position information, may obtain a projection region among the plurality of projectable regions.

According to one or more embodiments, based on the sensing data sensed by the at least one sensor 170, the at least one processor 140 may sense a movement of the position of the user and update the projection region, and transmit changed position information of the user to an external apparatus and the like through the communicator 120.

According to an embodiment, the at least one sensor 170 described above may further use various types of sensors such as, but not limited to, a distance sensor (e.g., a Radio Detection And Ranging (Radar), a Light Detection and Ranging (LiDAR), an IR sensor, an ultrasonic sensor and the like), a depth camera, a geo-magnetic sensor), a passive infrared sensor, a fall detection sensor, a pyro-electric Infrared (PTR) sensor, a gyro sensor for detecting angular velocity, an encoder for measuring a movement speed and the like of an electronic apparatus, and the like, in addition to the above-described camera and ToF sensor.

According to one or more embodiments, based on map information, a first projection region and a second projection region, the at least one processor 140 may obtain a moving path for reaching a position for projecting a second image onto the second projection region.

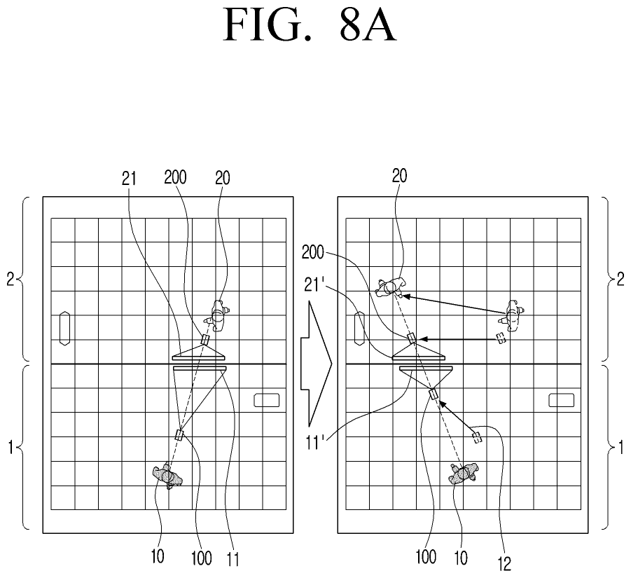

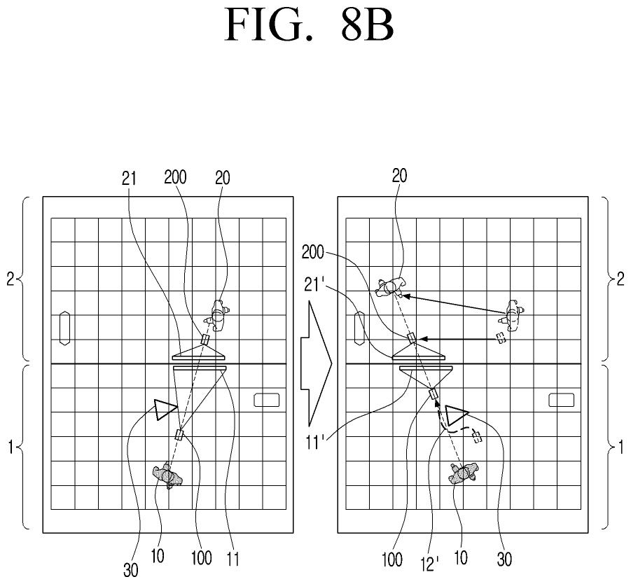

In an example case in which at least one object is identified through the at least one sensor 170 within a threshold distance from the electronic apparatus during a movement along a moving path, the at least one processor may update the moving path based on the identified object, and control the mover 160 to move along the updated moving path such that the projector 130 projects the second image onto the second projection region. Descriptions in relation to this are provided with reference to FIGS. 8A and 8B.

According to an embodiment, FIG. 3 illustrates an electronic apparatus including various additional elements, but the disclosure is not limited thereto, and such, according to another embedment, the electronic apparatus may be implemented in the way that part of the illustrated elements are omitted. Additionally, though not illustrated, the electronic apparatus may further include other elements.

For example, the electronic apparatus 100 may include a display.

According to an embodiment, the display may be an element for displaying an operation state or a notification message of the electronic apparatus 100. For example, the display include a user interface (UI) screen and the like. The display may be implemented as various types of displays such as a liquid crystal display (LCD), an organic light emitting diode (OLED) display, a plasma display panel (PDP) and the like. In the display, driving circuitry implemented in the form of an amorphous silicon thin film transistor (a-si TFT), a low temperature poly silicon (LTPS) TFT, an organic TFT (OTFT) and the like, a backlight unit and the like may be included together. According to an embodiment, the display may be implemented as a touch screen coupled with a touch sensor, a flexible display, a three-dimensional (3D) display and the like. According to an embodiment, the display may be implemented only with one or a plurality of light emitting diodes. The electronic apparatus 100 may allow the user to find the state of the electronic apparatus 100 intuitively by changing the display state of the display, depending on various states such as a state in which the electronic apparatus 100 is turned on, a state in which the electronics apparatus is operating normally, a state in which the electronic apparatus is short of power, or a state in which an error occurs and the like.

However, the configuration of the display is only part of various embodiments, and as such, according to another embodiment, the electronic apparatus 100 may not include the display. For example, the electronic apparatus 100 may be an apparatus provided with a display directly, or an apparatus connected with an external apparatus. For example, in the case where the electronic apparatus 100 is implemented as a set-top box, a One Connect box, a projector and the like, the operations of the electronic apparatus 100 described above may also be performed by an electronic apparatus including no display.

FIG. 4 is a view provided to explain an operation of an electronic apparatus according to one or more embodiments.

According to FIG. 4, the user 10 positioned in a first space 1 and the counterpart 20 positioned in a second space 2 may perform a video call with each other. For example, a projection region 11 seen by the user 10 may be a region onto which an image is projected by an electronic apparatus that is used by the user 10, and the image may be an image corresponding to an image of the counterpart 20, which is captured by an external apparatus. On the other hand, a projection region 21 seen by the counterpart 20 may be a region onto which an image is projected by an external apparatus that is used by the counterpart 20, and the image may be an image corresponding to an image of the user 10, which is captured by an electronic apparatus.

In an example case in which the counterpart 20 moves in the second space 2, the external apparatus may move to capture an image of the counterpart 20 seeing the projection region 21, and capture the image of the counterpart 20 in the moved position.

According to an embodiment, in the first space 1, the user 10 may see an image that is changed based on the movement of the counterpart 20. According to an embodiment, the position of the counterpart 20 is moved in the image, and accordingly, the user 10 positioned in the first space 1 may feel like the user 10 is talking with the counterpart 20 face to face in the same space.

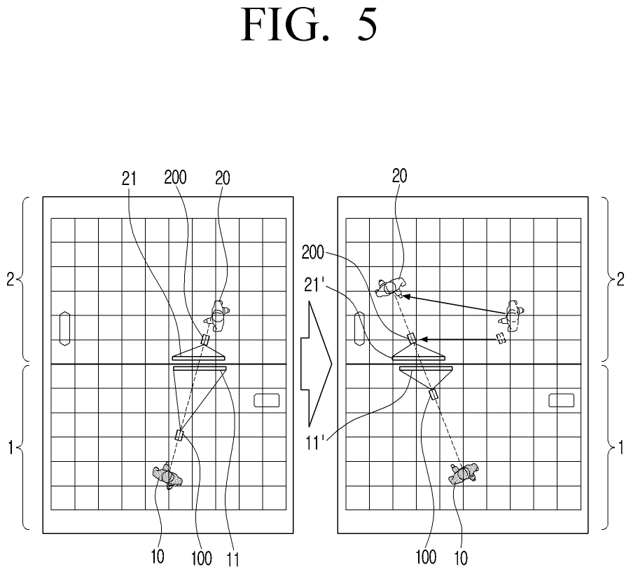

According to an embodiment, FIG. 4 illustrates a state in which the projection region is fixed as the counterpart 20 moves, but as the counterpart 20 moves, the projection region 11 of the first space 1 may be changed and moved together. For example, the electronic apparatus may obtain a projection region in the first space 1 based on a plurality pieces of position information that is obtained by the external apparatus in the second space 2. Detailed descriptions in relation to this are provided with reference to FIG. 5 described hereinafter.

FIG. 5 is a view provided to explain first position information and second position information, according to one or more embodiments.

For example, FIG. 5 is a 2D top view showing that the electronic apparatus 100, the external apparatus 200, the first space 1, the second space 2, the user 10, the counterpart 20 and each projection region 11, 21, 11′, 21′ described above are seen from above.

According to FIG. 5, the counterpart 20 moves from right to left, and accordingly, each projection region 11, 21 may be moved to a new region 11′, 21′.

According to one or more embodiments, the electronic apparatus 100 may control the projector 130 to project a first image onto the first projection region 11 obtained based on first position information that is received from the external apparatus 200 through the communicator.

For example, the first position information may denote position information on a second space 2 in the case where the counterpart 20 is in a first position, in the second space 2. The first position information may be obtained by the external apparatus 200.

According to an embodiment, the position information may include the first position of the counterpart 20 using the external apparatus 200 in the second space 2, but not limited thereto, and include information on a position of the projection region 21 and a position of the external apparatus 200.

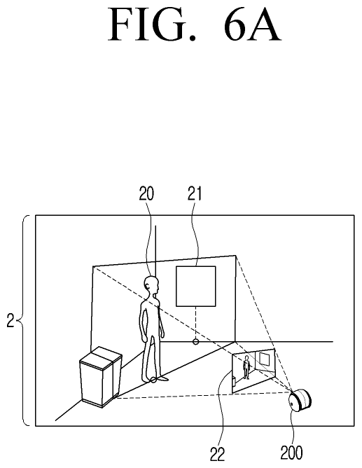

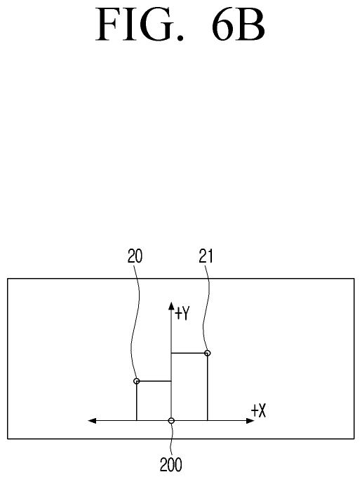

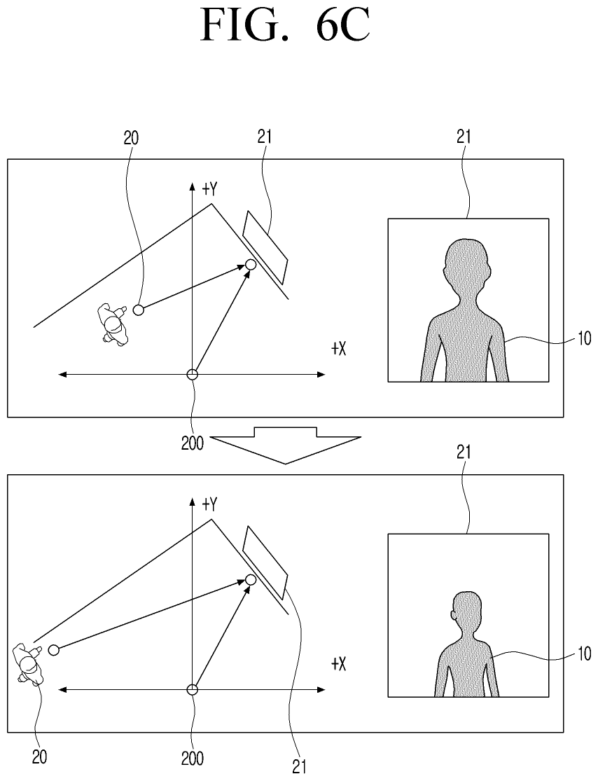

According to an embodiment, the first position of the counterpart 20 and the position of the projection region 21 may be obtained through at least one sensor provided in the external apparatus 200. Descriptions in relation to this are provided with reference to FIG. 6A and below described hereinafter.

The position of the external apparatus 200 may be obtained based on map information of the second space 2 obtained previously by the external apparatus 200 through the at least one sensor provided in the external apparatus 200.

According to an embodiment, each position may include a coordinate, and each coordinate may include a coordinate value for each of a plurality of components (e.g., (x1, y1), (x2, y2)). This may be the case with second position information described hereinafter.

According to an embodiment, the electronic apparatus 100 may receive first position information. For example, the first position information may be received from a server and the like capable of performing communication with an external apparatus. The second position information may also be received in a similar manner as the first position information.

According to an embodiment, the electronic apparatus 100 may identify a first projection region based on the received first position information. For example, the first projection region may correspond to a region into which an image of the counterpart 20 is projected in a state prior to the movement of the counterpart 20.

According to an embodiment, the electronic apparatus 100, as illustrated in FIG. 5, may identify the first projection region as a position in which the user 10 and the counterpart 20 appear as if they face each other, with a wall between the first space 1 and the second space 2. For example, based on first position information including information that the counterpart 20 in the second space 2 is positioned at an upper end of a right side (or a coordinate of the counterpart 20), the electronic apparatus 100 may identify a region placed at a right side as the first projection region 11, with respect to the user 10 facing a projection surface of the first space 1.

According to an embodiment, the first projection region 11 may be placed on a straight line connecting the user 10 and the counterpart 20, in the case where the first space 1 and the second space 2 are connected virtually as illustrated in FIG. 5. That is, the first space 1 and the second space 2 may not correspond to spaces that are actually adjacent. However, the electronic apparatus 100 may connect the first space 1 and the second space 2 through a projection surface of each of the first space and the second space to identify a positon of the first projection region 11, and identify the first projection region through the virtual straight line connecting the user 10 and the counterpart 20. By applying the same theory as the above-described one, the electronic apparatus 100 may obtain a second projection region 11′ described hereinafter.

According to an embodiment, identifying the first projection region 11 based on the position (coordinate) of the counterpart 20 is described above, in an example case in which the position of the counterpart 20 is included in the first position information, but the disclosure is not limited thereto, and as such, in another example case, the first projection region 11 may also be identified based on a position of an existing projection region 21 and a positon of the external apparatus 200 in the second space 2, which may be included in the first position information. For example, the electronic apparatus 100 may also identify the first projection region 11 based on at least one of the position of the projection region 21 and the position of the external apparatus 200 in the second space 2, regardless of the position of the counterpart 20.

The electronic apparatus 100 may project a first image onto the identified first projection region 11. For example, the first image may be an image corresponding to an image of the counterpart 20 positioned in a first position, which is captured by the external apparatus 200 in the state where the counterpart 20 is positioned in the first position. For example, the first image may correspond to a captured image of the counterpart 20. However, the first image is not limited thereto, and the first image may correspond to an image in which resolution and the like of the captured image of the counterpart 20 are adjusted. That is, the first image may not be limited to an image itself of the counterpart 20, which is captured and transmitted by the external apparats 200, and may correspond to an image in which the size and luminance and the like are adjusted to allow the electronic apparatus 100 to properly project the appearance of the counterpart 20. An example case in which the second image is adjusted is described hereinafter.

In an example case in which second position information different from the first position information is received from the communicator 120 while an image is projected to the first projection region 11, the electronic apparatus 100 may obtain a second projection region 11′ different from the first projection region 11 based on the second position information.

For example, the second position information different from the first position information may denote position information on a second space 2 in the case where the counterpart 20 has moved from the first position to a second position. The second position information may correspond to position information in the case where the counterpart 20 is positioned in the second position different from the first position, and correspond to position information different from the first position information. The second position information may correspond to information obtained by the external apparatus 200.

According to an embodiment, like the first position information, the second position information may include a position of a changed projection region 21′ in the second space 2, in the case where the counterpart 20 has moved, as well as a position of the counterpart 20 positioned in the second position, and include a changed position of the external apparatus 200 based on the movement of the counterpart 20.

Additionally, the electronic apparatus 100 may obtain a second projection region 11′ based on the received second positon information. For example, the second projection region 11′ may correspond to a region onto which an image of the counterpart 20 is projected after the counterpart 20 has moved.

For example, in the same or similar way as the electronic apparatus 100 identifies the first projection region 11, the electronic apparatus 100, as illustrated in FIG. 5, may identify the second projection region as a position in which the user 10 and the counterpart 20 appear as if they face each other, with a wall between the first space 1 and the second space 2. For example, based on the second position information including information that the counterpart 20 in the second space 2 is positioned at an upper end of a left side (or a coordinate of the counterpart 20) or information that the counterpart 20 has moved to the left, the electronic apparatus 100 may obtain a region placed at the left side as the second projection region 11′, with respect to the user 10 facing the projection surface of the first space 1.

For example, like the first projection region 11, the second projection region 11′ may be placed on a straight line connecting the user 10 and the counterpart 20 in the case where the first space 1 and the second space 2 are connected virtually as illustrated in FIG. 5.

According to an embodiment, obtaining the second projection region 11′ based on the position (coordinate) of the counterpart is described above, in an example case in which a position after the movement of the counterpart 20 is included in the second position information, but the disclosure is not limited thereto, and as such, in another example case, the second projection region 11′ may also be identified based on the position of the projection region 21 and the positon of the external apparatus 200 in the second space 2, which may be included in the second position information. Additionally, the electronic apparatus 100 may also obtain the second projection region 11′ based on a changed position of the user in the case where the user 10 has moved.

For example, even in a case in which both the user 10 and the counterpart 20 have moved, the electronic apparatus 100 may obtain the second projection region 11′ placed on a straight line connecting the user 10 and the counterpart 20 in the case where the first space 1 and the second space 2 are connected virtually as illustrated in FIG. 5.

The electronic apparatus 100 may project a second image corresponding to an image of the counterpart 20 positioned in the second position, which is captured by the external apparatus 200, onto the obtained second projection region 11′. For example, the second image may correspond to an image of the counterpart 20, which is captured by the external apparatus 200, in the state where the counterpart 20 has moved to the second position.

Accordingly, the user 10 may feel like the user 100 is talking with the counterpart 20 with a wall between the user 10 and the counterpart 20, while performing a video call through the electronic apparatus 100. Additionally, since in the case where the user 10 or the counterpart 20 moves in their own space 1, 2, a region onto which the electronic apparatus 100 projects an image of the counterpart 20 may be changed based on the movement of the user 10 or the counterpart 20, the user 10 may perform a video call having a 3D stereoscopic effect as if the user 10 is talking with the counterpart 20 in the same space.

According to an embodiment, the electronic apparatus 100 may control at least one of the driver 150 and the mover 160 such that the projection unit may project the second image to the obtained second projection region. That is, in the case where the projection region is changed from the first projection region 11 to the second projection region 11′, the electronic apparatus 100 may adjust a projection direction through the driver 150, or may move through the mover 160, to project the second image onto the second projection region 11′, and may control both the driver 150 and the mover 160 to project the second image onto the second projection region 11′. Since descriptions in relation to this are provided above with reference to FIG. 3, repetitive description is avoided.

As described above, the electronic apparatus 100 may obtain the first projection region 11 and the second projection region 11′ respectively based on the first position information or the second position information. For example, the electronic apparatus 100 may obtain the first projection region 11 and the second projection region 11′, based on a position of the counterpart 20, or based on positions of the user 10 and the counterpart 20. The position of the user 10 may be obtained by the electronic apparatus 100, and the position of the counterpart 20 may be obtained by the external apparatus 200. An identical theory may be applied to an operation of identifying the position of the user 10 and the position of the counterpart 20 respectively by the electronic apparatus 100 and the external apparatus 200, and hereinafter, an operation of identifying the positon of the counterpart 20 by the external apparatus 200 is described in detail, such that the electronic apparatus 100 may obtain the projection region 11, 11′.

FIGS. 6A-6C are views provided to explain an operation of obtaining position information, according to one or more embodiments.

According to FIG. 6A, the external apparatus 200 may capture an image of the counterpart 20 and a projection region 21 placed in the second space 2, and obtain a RGB image 22.

The external apparatus 200 may obtain a position of the counterpart 20 and a position of the projection region 21 from the obtained RGB image 22.

For example, the external apparatus 200 may obtain a RGB image 22 by capturing an image of the counterpart 20 and the projection region 21 through a provided camera. For example, the RGB image 22 may correspond to the image of the counterpart, captured for the counterpart 20 to perform a video call with the user 10, or correspond to an image different from the image captured for a video call. In the RGB image 22 captured by the external apparatus 200, a pixel coordinate system (x, y) of a reference point of the counterpart 20 (e.g., a position of the counterpart on the ground surface) and a reference point of the positon of the projection region 21 onto which an image is to be projected (e.g., a position of the projection region on the ground surface) may be obtained. According to an embodiment, the external apparatus 200 may obtain a relative coordinate of the counterpart 20 and the projection region 21, through an internal parameter fx, fy, cx, cy or 3D pose information R, t and the like of the camera. For example, fx and fy may correspond to a focal length of the camera, and cx an cy may correspond to a principal point. For example, the focal length may denote a distance from an optical center of a camera lens to an image sensor. For example, the principal point may correspond to a center point of the image sensor. For example, R may denote a rotation matrix (3×3), and t may correspond to a transformation vector (3D). The external apparatus 200 may obtain coordinates of the counterpart 20 and the projection region 21 by using the internal parameter fx, fy, cx, cy and 3D pose information R, t of the camera through a geometric calculation or a homography method and the like.

For example, in the case where the external apparatus 200 obtains the coordinate through the geometric calculation, the external apparatus 200 may transform the above-described pixel coordinate (x, y) into a normalized image coordinate (u, v) through the internal parameter fx, fy, cx, cy. Then from the normalized image coordinate (u, v), the external apparatus 200 may obtain the coordinates of the counterpart 20 and the projection region 21 included in the RGB image 22, through a height of the camera from the ground surface and a tilting angle of the camera.

Accordingly, the external apparatus 200, as illustrated in FIG. 6B, may obtain the coordinates of the counterpart 20 and the projection region 21, in which the external apparatus 200 is the origin. For example, +Y may correspond to a direction of an optical axis of the camera, and +X may correspond to a direction perpendicular to the optical axis.

FIG. 6B shows that the external apparatus 200 obtains the coordinates of the counterpart 20 and the projection region 21 with respect to the external apparatus 200, but the disclosure is not limited thereto, and as such, according to another embodiment, the external apparatus 200 may obtain 2D coordinates of the counterpart 20, the projection region 21 and the external apparatus 200, in which the second space 2 is a virtual 2D coordinate system.

For example, the external apparatus 200 may obtain and store map information of the second space 2. For example, the external apparatus 200 may capture an image of other regions of the second space 2 and obtain a plurality of images in addition to the RGB image 22 in which the image of the counterpart 20 or the projection region 21 is captured. Based on the plurality of obtained images, the external apparatus 200 may generate and store map information on the entire region of the second space 2. Based on the stored map information, the external apparatus 200 may obtain a 2D coordinate of the external apparatus 200 in the second space 2. Additionally, based on the map information, the external apparatus 200 may obtain 2D coordinates of the counterpart 20 and the projection region 21 in the second space 2.

The operation in which the external apparatus 200 obtains the coordinates of the counterpart 20 and the projection region 21 through the camera provided in the external apparatus 200, and generates the map information and obtains the coordinate of the external apparatus 200 through a plurality of RGB images in which the image of the second space 2 is captured is described above, but the disclosure is not limited thereto, and as such, according to another embodiment, the external apparatus 200 may obtain the coordinate or map information described above by using various types of sensors in addition to the camera.

For example, the external apparatus 200 may obtain depth values of the counterpart 20 and the projection region 21 with respect to a ToF sensor through the ToF sensor provided. For example, the external apparatus 200 may obtain a depth value through a ToF value obtained through the ToF sensor. The depth value may be referred to as “distance”, “depth”, “distance value”, depth” and the like in various ways. The external apparatus 200 may obtain a plurality of depth values through the ToF sensor while moving in the second space 2. The external apparatus 200 may obtain the coordinates of the counterpart 20 and the projection region 21 by using the plurality of depth values that is obtained by scanning the second space 2 and by using the depth values of the counterpart 20 and the projection region 21.

According to an embodiment, the external apparatus 200 may continue to obtain the coordinate of the counterpart 20 or the projection region 21. For example, even in a case in which the position of the counterpart 20 is moved in the second space 2, the external apparatus 200 may obtain the coordinates of the counterpart 20 and the projection region 21, by using the above-described theory.

Referring to FIG. 6C, the external apparatus 200 may project an image onto a projection region 21, and the counterpart 20 may see the appearance of the user 10 through the image. For example, the image may correspond to an image in which the image of the front of the user 10 is captured by the electronic apparatus. For example, the positions of the counterpart 20 and the projection region 21 may correspond to relative coordinates obtained by the external apparatus 200 as illustrated in FIG. 6B.

According to an embodiment, in the case where the counterpart 20 moves to another position, the external apparatus 200 may obtain and update a coordinate of the counterpart 20 in the same way as the coordinate of the counterpart 20 is obtained and updated before the counterpart 20 moves. As described above, the external apparatus 200 may obtain a new coordinate by obtaining the coordinate of the counterpart 20 or the projection region 21 continuously, even in the case where the position of the counterpart 20 is changed.

Accordingly, the external apparatus 200 may continue to obtain the coordinate of the counterpart 20, projection region 21 or external apparatus 200 and transmit the obtained coordinate to a server.

As described above, the operations of the external apparatus 200 described above may be performed by the electronic apparatus 100 in the same way. That is, the electronic apparatus 100 may obtain the coordinate of the user 10 or the projection region 11 through the camera or the ToF sensor and the like included in the at least one sensor 170, and transmit the obtained coordinate to the server or the external apparatus 200.

Accordingly, the electronic apparatus 100 and the external apparatus 200 may share the coordinate obtained by each of them through the server. Additionally, the electronic apparatus 100 and the external apparatus 200 may share position information in real time, and change the projection region based on the movement of the user 10 or the counterpart 20, to provide a video call function, as if the user is talking with the counterpart in the same space.

According to an embodiment, in the case where a direction in which the counterpart 20 faces the projection region 21 is changed as the counterpart 20 moves, an image different from an image prior to the movement of the counterpart 20 may be projected onto the projection region 21. For example, before the counterpart 20 moves, an image displaying the front of the user 10 may be projected onto the projection region 21, but after the counterpart 20 moves, an image displaying the right side of the user 10 may be projected onto the projection region 21.

For example, as the counterpart 20 moves, the electronic apparatus 100 may be moved to a position for capturing an image of the side of the user 10. The electronic apparatus 100 may capture an image of the side of the user 10 in the moved position, and then share the captured image with the server. Additionally, the external apparatus 200 may receive the captured image of the user 10's side and project the same onto the projection region 21.

According to an embodiment, the same operation may be performed even in the case where the position of the user 10 of the electronic apparatus 100 is moved, the same operation may be performed. That is, even in the case were the position of the user 10 is moved in contrast with the illustration of FIG. 6C, a direction in which the user 10 faces the projection region may be changed. According to an embodiment, the external apparatus 200 may move to a position for capturing an image of the side of the counterpart 20 and capture an image of the counterpart 20, and the electronic apparatus 100 may receive the image of the counterpart 20 and project the image onto the projection region.

Accordingly, as the direction in which each of the user 10 or the counterpart 20 faces the projection region is changed based on the movement of each of the user 10 or the counterpart 20, causing, the electronic apparatus 100 or the external apparatus 200 may capture an image by changing a capturing angle. Accordingly, the electronic apparatus 100 and the external apparatus 200 may provide a video call function producing a more lively 3D effect.

FIG. 7 is a view provided to explain an operation of capturing an image based on a distance, according to one or more embodiments.

According to FIG. 7, the electronic apparatus 100 may project a first image onto a first projection region 11, and after the counterpart 20 moves, project a second image onto a second projection region 11′. According to an embodiment, the user 10 in a first space 1 is spaced apart from the first projection region 11 by a distance a, and the counterpart 20 in a second space 2 may be spaced apart from a projection region 21 by a distance b. After the counterpart 20 moves, the user 10 may be spaced apart from the second projection region 11′ by a distance c in the first space 1, and the counterpart 20 may be spaced apart from a changed projection region 21′ by a distance d in the second space 2.

For example, a projection surface may correspond to a surface on which a plurality of projection regions 11, 11′, 21, 21′ may be placed in each of the first space 1 and the second space 2.

The electronic apparatus 100 may obtain the distance a and distance c by obtaining relative coordinates of the user 10 and the projection region 11, 11′ described above. According to an embodiment, the electronic apparatus 100 may obtain the distance a and the distance c by using map information of the first space 1. The external apparatus 200 may obtain the distance b and the distance d by obtaining relative coordinates of the counterpart 20 and the projection region 21, 21′ described above. According to an embodiment, the external apparatus 200 may obtain the distance b and the distance d by using map information of the second space 2. However, obtaining the distances by the electronic apparatus 100 and the external apparatus 200 is not limited thereto.

According to one or more embodiments, the first image may be an image corresponding to an image of the counterpart, which is captured by the external apparatus 200 in the second space 2 based on a distance between a region onto which a third image different from the first image and the second image is projected and a first position. For example, the third image may correspond to an image of the user 10, which is captured by the electronic apparatus 100.

For example, the external apparatus 200 may capture an image of the counterpart 20 in the first position based on the distance b. For example, the external apparatus 200 may capture an image of the counterpart 20 from a distance b, between the projection region 21 and the counterpart 20, and obtain the first image. For example, capturing an image from a distance b may denote capturing an image to obtain an image looking as if the external apparatus 200 is spaced apart from the counterpart 20 by the distance b, through a zoom function of the camera of the external apparatus 200. This may also be applied to the second image described hereinafter in the same way.

According to an embodiment, according to one or more embodiments, the second image may be an image corresponding to an image of the counterpart, which is captured by the external apparatus 200 in the second space 2, based on a distance between a region onto which a fourth image different from the first image and the second image is projected and a second position. For example, the fourth image may correspond to an image of the user 10, which is captured by the electronic apparatus 100, in the case where the counterpart 20 has moved.

For example, even in the case where the counterpart 20 has moved, the external apparatus 200 may capture an image of the counterpart 20 in the second position from a distance d and capture the second image, in the same way.

According to an embodiment, the external apparatus 200 may obtain the first image or the second image by capturing an image of the counterpart 20, based on a distance between the user 10 in the first space 1 and the first projection region 11 or the second projection region 11′ as well as a distance between the counterpart 20 positioned in the first position or the second position in the second space 2 and the projection region 21, 21′.

According to one or more embodiments, the first image may be an image corresponding to an image of the counterpart 20, which is captured by the external apparatus 200 in the second space 2, based on the distance between the region onto which the third image different from the first image and the second image is projected and the first positon and based on a distance between the position of the user 10 of the electronic apparatus 100 and a position of the first projection region 11.

For example, the external apparatus 200 may receive the distance a obtained by the electronic apparatus 100, capture an image of the counterpart 20 from the distance a and the distance b, and obtain the first image. That is, the external apparatus 200 may obtain the first image by capturing an image of the counterpart 20 from a distance a+b as a total of the distance a and the distance b. For example, capturing an image from the distance a+b may denote capturing an image to obtain an image looking as if the external apparatus 200 is spaced apart from the counterpart 20 by the distance a+b through a zoom function of the camera of the external apparatus 200. This may also be applied to the second image described hereinafter in the same or similar way.

According to one or more embodiments, the second image may correspond to an image of the counterpart 20, which is captured by the external apparatus 200 in the second space 2 based on the distance between the region onto which the fourth image different from the first image and the second image is projected and the second positon and based on a distance between the position of the user of the electronic apparatus 100 and a position of the second projection region 11′.

For example, the external apparatus 200 may receive the distance c obtained by the electronic apparatus 100, capture an image of the counterpart 20 from the distance c and the distance d, and obtain the first image. That is, the external apparatus 200 may obtain the first image by capturing an image of the counterpart 20 from a distance c+d as total of the distance c and the distance d.

Accordingly, the electronic apparatus 100 may provide an effect in which the counterpart positioned at the distance a+b becomes far by the distance c+d as the user 10 moves, providing a lively video call function as if the user 10 and the counterpart 20 are talking with each other while they are moving in the same space.

According to an embodiment, the electronic apparatus 100 may project the first image onto the first projection region 11 that is placed at the right side in a direction of angle θ, in the state of facing the projection surface, with respect to a straight line perpendicular to the projection surface of the first space 1. According to an embodiment, the external apparatus 200 may also project the third image onto the projection region 21 that is placed at the right side in the direction of angle θ in the state of facing the projection surface, with respect to the straight line perpendicular to the projection surface, in the same or similar way. According to an embodiment, the electronic apparatus 100 may project the second image onto the second projection region 11′ that is placed at the left side in a direction of angle θ′ with respect to the straight line perpendicular to the projection surface after the counterpart 20 has moved. According to an embodiment, the external apparatus 200 may project the fourth image onto the projection region 21′ that is placed on the left side in the direction of angle θ′, with respect to the straight line perpendicular to the projection surface. For example, the external apparatus 200 may obtain the angle θ and θ′ based on the coordinate of the counterpart 20, and the electronic apparatus 100 may receive the angle θ and θ′ obtained by the external apparatus 200 and the like, and based on the angle θ and θ′, obtain the first projection region 11 and the second projection region 11′.

Accordingly, the electronic apparatus 100 may share a projection direction (or an angle) as well as a distance of the user 10 and the counterpart 20 from the projection region 11, 11′ with the external apparatus 200, providing a realistic video call function, as if the user 10 and the counterpart 20 are facing each other in the same space.

FIGS. 8A and 8B are views provided to explain a moving path, according to one or more embodiments.

According to FIG. 8A, the electronic apparatus 100 may project a first image onto a first projection region 11, and as the counterpart moves from a first position to a second position in the second space 2, the electronic apparatus 100 may project a second image onto a second projection region 11′. According to an embodiment, the electronic apparatus 100 may be move along a moving path 12 based on the first projection region 11 and the second projection region 11′.

According to one or more embodiments, the electronic apparatus 100 may store map information corresponding to a first space 1 in which the electronic apparatus is placed, and based on the map information, first projection region 11 and second projection region 11′, obtain the moving path 12 for reaching a position for projecting the second image onto the second projection region 11′.

In an example case in which second position information is received based on the movement of the counterpart 20, the electronic apparatus 100 may move to a position for projecting the second image onto the second projection region 11′. For example, the position for projecting the second image may be based on a focal length of the projector 130 as well as the map information corresponding to the first space 1, a position of the first projection region 11 and a position of the second projection region 11′. For example, in the case where the projector 130 includes an ultra-short focus lens rather than the projection-type lens described above, the electronic apparatus 100 may move to a position (e.g., dozens of centimeters from a wall surface) near a projection surface to project the second image clearly as illustrated in FIG. 8A. On the other hand, in the case where the projector 130 includes a projection-type lens, the electronic apparatus 100 may move a relatively long distance (e.g., a few meters from a wall surface) and project the second image.

According to an embodiment, the electronic apparatus 100 may obtain a moving path for moving by avoiding at least one object, based on position information of the at least one object included in the map information. However, in the case where the map information is not updated for a long period, position information of a new object may not be included in the map information stored previously.

According to FIG. 8B, an object 30 may be placed in the first space 1. According to an embodiment, the electronic apparatus 100 may not move along the moving path 12 obtained in FIG. 8A.

The electronic apparatus 100, according to one or more embodiments, may identify at least one object 30 within a threshold distance from the electronic apparatus 100 through at least one sensor 170 while moving along the moving path 12.

For example, the electronic apparatus 100 may identify at least one object 30 within a threshold distance through at least one sensor 170, while moving along the moving path 12. For example, the threshold distance may correspond to a minimum gap allowing the electronic apparatus 100 to move along the moving path 12 without contacting the at least one object 30. For example, the gap may denote distance between a center point of the electronic apparatus 100 or a position of the at least one sensor 170, and a reference point of the at least one object. For example, the reference point of the object may correspond to a point of the object, which is closest to the electronic apparatus 100. However, the threshold distance may not be limited thereto, and may be set according to manufacturer or user settings in various ways.

According to one or more embodiments, the electronic apparatus 100 may update the moving path 12 based on the identified object. For example, the electronic apparatus 100 may update an existing moving path 12 to a moving path 12′ allowing the electronic apparatus 100 to be spaced apart from the at least one object 30 identified by the threshold distance or greater and to move. Then the electronic apparatus 100 may control the mover 160 to move along the updated moving path 12′ such that the projector 130 projects the second image onto the second projection region 11′.

Accordingly, the electronic apparatus 100 may update the moving path newly in in an example case in which a new object 30 is identified while the electronic apparatus 100 moves to change the projection region as the counterpart 20 moves. The electronic apparatus 100 may project an image by changing the projection region freely to respond to the movement of the counterpart 20, based on such an autonomous travel, even in the case where an object is present.

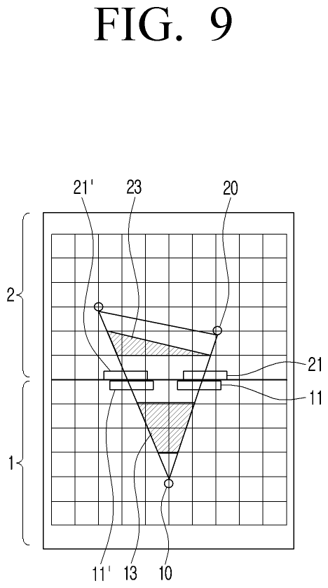

FIG. 9 is a view provided to explain a movement region of an electronic apparatus, according to one or more embodiments.

According to FIG. 9, the electronic apparatus 100 may move in a first region 13 of the first space 1, and the external apparatus 200 may move in a second region 23 of the second space 2.

For example, the electronic apparatus 100 may project an image within a focal length range of the projector 130. Additionally, the electronic apparatus 100 may capture an image of the user 10 within a focal length range of a camera included in at least one sensor 170. That is, in an example case in which the electronic apparatus 100 is placed outside the first region 13, the electronic apparatus 100 may not capture a clear image of the user since the electronic apparatus 100 is outside the focal length range of the camera, or may not project an image clearly since the electronic apparatus 100 is outside the focal length range of the projector 130. Due to a limitation of the focal length range of each of the projector 130 and the camera, a range in which the electronic apparatus 100 is movable may be limited to the first region 13. This may be the case with the second region 23 in which the external apparatus 200 is movable.

According to an embodiment, in the case where the projector 130 described above includes both the ultra-short focus lens and the projection-type lens or implemented as a hybrid-type projector capable of switching the ultra-short focus method and the projection-type method, the electronic apparatus 100 may perform both an image projection function and an image capturing function normally while the electronic apparatus 100 is placed outside the first region 13. For example, due to a limitation of the focal length of the camera included in the electronic apparatus 100, there may be a case where a clear image of the user 10 is captured only in a closest position. According to an embodiment, the electronic apparatus 100 may capture an image of the user 10 by using a short focus, at a distance closer to the user 10, outside the first region 13, and switch the projection method from the ultra-short focus method to the projection-type method and project the image at a long distance from the projection surface. On the contrary, in the case where a clear image of the user 10 is captured only from a long distance due to a limitation of the focal length of the camera of the electronic apparatus 100, the electronic apparatus 100 may certainly switch the projection method to the ultra-short focus method and project the image. The above-described theory may also be applied to the second region 23 in which the external apparatus 200 is movable in the same way.

FIG. 10 is a view provided to explain a projection region, according to one or more embodiments.

According to FIG. 10, the electronic apparatus 100 may obtain a partial region of a first projection surface onto which an image is projectable in the first space 1, as a second projection region. Additionally, the external apparatus 200 may project an image onto a partial region of a second projection surface onto which an image is projectable in the second space 2.

According to one or more embodiments, the electronic apparatus 100 may obtain a plurality of projection regions for the electronic apparatus 100 to project an image, based on sensing data obtained from at least one sensor 170. For example, the sensing data may include a RGB image obtained through the camera or a plurality of depth values obtained through the ToF sensor. However, the sensing data are not limited thereto.

According to an embodiment, the plurality of projection regions may denote a region that is appropriate for the electronic apparatus 100 to project an image. For example, the electronic apparatus 100 may perform RGB segmentation through the RGB image obtained by using the camera, and then based on segmentation information, identify a projectable region. For example, the segmentation may correspond to a process of analyzing pixel information included in the RGB image and identifying and separating a plurality of objects. In another example, the electronic apparatus 100 may obtain a depth map corresponding to a partial region of the first space through the ToF sensor, and based on the obtained depth map, identify whether a corresponding space is a projectable region.

According to one or more embodiments, the electronic apparatus 100 may project a first image onto a first projection region 11 included in the plurality of projection regions and obtain a second projection region included in the plurality of projection regions. For example, the electronic apparatus 100 may identify the first projection region and the second projection region based on each of first position information and second position information in a plurality of regions identified as being appropriate to project an image.

According to an embodiment, the first projection surface occupied by a plurality of projection regions corresponding to the first space 1 and the second projection surface occupied by a plurality of projection region corresponding to the second space 2 may have a different size.

According to one or more embodiments, based on a surface area of each of the first projection surface occupied by the plurality of projection regions and the second projection surface corresponding to the second space 2 in which the external apparatus 200 is positioned, the electronic apparatus 100 may control the projector 130 such that the projector 130 may adjust the size of the first projection region and project the first image. Additionally, the electronic apparatus 100 may obtain a second projection region 14 of a size adjusted based on the surface area of each of the first projection surface and the second projection surface.

For example, the size of the first projection surface may be W1×H1, and the size of the second projection surface may be W2×H2. For example, W may denote width, and H may denote height. W1 and W2 may be different values, and H1 and H2 may be different values. In an example case in which the electronic apparatus 100 and the external apparatus 200 respectively project each image onto a projection region of the same size regardless of the size of the first projection surface and the size of the second projection surface, there may be a problem with a change in the projection region based on the movement of the user 10 or the counterpart 20 due to a limitation of the size of each projection surface.

According to an embodiment, both the electronic apparatus 100 and the external apparatus 200 may adjust the size of the projection region respectively, based on the surface area (W1×H1) of the first projection surface and the surface area (W2×H2) of the second projection surface. For example, the electronic apparatus 100 and the external apparatus 200 may adjust the size of the projection region according to at least one of the equations W1:X1=W2:X2, H1:Y1=H2:Y2 and (X1×Y1): (W1×H1)=(X2×Y2): (W2×H2). Accordingly, the electronic apparatus 100 may project an image displaying the counterpart 20 onto a projection region 14 (the first projection region of an adjusted size or the second projection region of an adjusted size) of an adjusted size, as illustrated in FIG. 10. According to an embodiment, the external apparatus 200 may also project an image displaying the user 10 onto a projection region 24 of an adjusted size in the same way.

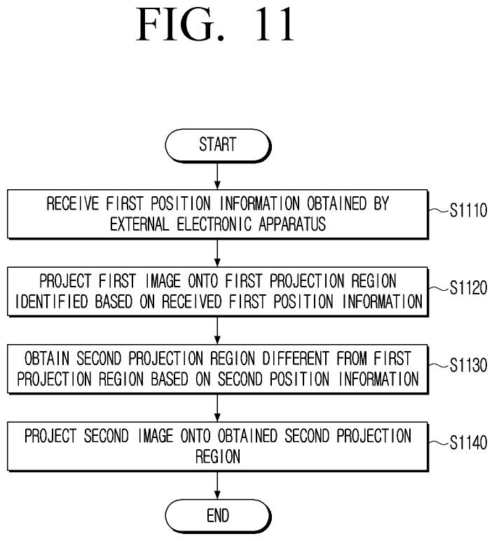

FIG. 11 is a flowchart provided to explain a control method of an electronic apparatus of the disclosure.

According to FIG. 11, in operation S1110, the method may include receiving first position information obtained by an external apparatus (S1110). For example, the electronic apparatus 100 may receive first position information obtained by an external apparatus.

According to one or more embodiments, the first position information may include a first position of the counterpart corresponding to the external apparatus in an external space where the external apparatus is placed.

According to an embodiment, in operation S1120, the method may include projecting a first image onto a first projection region obtained based on the received first position information. For example, the electronic apparatus 100 may project a first image onto a first projection region obtained based on the received first position information.

According to one or more embodiments, the first image may be an image corresponding to an image of the counterpart positioned in the first position, which is captured by the external apparatus.

According to an embodiment, in operation S1130, the method may include obtaining a second projection region different from the first projection region based on second position information. For example, in a case in which second position information different from the first position information is received while the image is projected onto the first projection region, the electronic apparatus 100 may obtain a second projection region different from the first projection region based on the second position information.

According to one or more embodiments, the second position information may include a second position to which the counterpart corresponding to the external apparatus in the external space where the external apparatus is placed moves from the first position.

According to an embodiment, in operation S1140, the method may include projecting a second image onto the obtained second projection region. For example, the electronic apparatus 100 may project a second image onto the obtained second projection region.

According to one or more embodiments, the second image may be an image corresponding to an image of the counterpart positioned in the second position, which is captured by the external apparatus.

According to an embodiment illustrated in FIG. 11, the electronic apparatus 100 may share the position information and the like with the external apparatus, and project the image of the counterpart by changing the projection region based on the movement of the counterpart, providing a video call function to the user, as if the user is talking with the counterpart face to face in the same space.

Various methods described with reference to FIG. 11 may be performed by an electronic apparatus having the configuration illustrated in FIG. 2, but not limited thereto, and the methods may be performed by an electronic apparatus having various configurations.

According to an embodiment, in FIG. 11, order of all the step are mapped for convenience of description, but certainly, the steps may be performed regardless of their order, or order of steps and the like that are performable in parallel may not be limited to thereto.

According to an embodiment, methods according to at least part of various above-described embodiments of the disclosure may be implemented in the form of an application installable in a related art electronic apparatus.

Additionally, methods according to at least part of various above-described embodiments of the disclosure may be implemented only by upgrading software or hardware of a related art electronic apparatus.

Further, methods according to at least part of various above-described embodiments of the disclosure may also be performed through an embedded server provided in an electronic apparatus, or at least one external server.

According to embodiments, the embodiments described above may be implemented with software including instructions stored in a storage medium readable by a machine (e.g., a computer). The machine, as an apparatus capable of calling the stored instructions from the storage media and operating according to the called instructions, may include the electronic apparatus (e.g., electronic apparatus (A)) according to one or more embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. For example, the term “non-transitory” only means being tangible and including no signal (e.g., electromagnetic waves) while the term does distinguish semi-permanent or temporary storage of data in the storage medium. For example, the “non-transitory storage medium” may include a buffer where data are temporarily stored. According to embodiments, the methods according to various embodiments set forth herein may be provided in a computer program product. The computer program product may be exchanged between a seller and a purchaser as a commodity. The computer program product may be distributed in the form of a machine-readable storage medium (e.g., compact disc read only memory (CD-ROM)) or distributed (e.g., downloaded or uploaded) online through an application store (e.g., Play Store™) or directly between two user apparatus (e.g., smartphones). In the case of online distribution, at least part of the computer program product (e.g., a downloadable app) may be stored at least temporarily, or generated temporarily in a machine-readable storage medium such as a server of a manufacturer, a server of an application store, or memory of a relay server.

The various embodiments set forth herein may be implemented with software including instructions stored in a storage medium readable by a machine (e.g., a computer). The machine, as an apparatus capable of calling the stored instructions from the storage media and operating according to the called instructions, may include the electronic apparatus (e.g., electronic apparatus 100 according to one or more embodiments.

Based on the instructions executed by a processor, the processor may perform functions corresponding to the instructions directly or by using other elements under the control of the processor. The instructions may include a code generated or executed by a compiler or an interpreter.

While example embodiments of the disclosure are illustrated and described above, embodiments are not limited to the embodiments set forth herein, and certainly, various modifications thereof may be made by one skilled in the art to which the disclosure pertains, without departing from the scope the disclosure claimed in the section of claims, and are not to be understood as separating from the technical spirit or prospect of the disclosure.

What is claimed is:

1. An electronic apparatus comprising:
a projector;
memory configured to store at least one instruction;
a communicator; and
at least one processor connected to the projector, the communicator and the memory,
wherein, when executed by the at least one processor, the at least one instruction is configured to:
receive first position information from an external apparatus through the communicator,
control the projector to project a first image onto a first projection region obtained based on the first position information;
receiving second position information different from the first position information through the communicator while the first image is projected onto the first projection region,
obtain a second projection region different from the first projection region based on the second position information; and
control the projector to project a second image corresponding to the second position information onto the second projection region.

2. The electronic apparatus as claimed in claim 1, further comprising:
a driver configured to adjust a projection direction of the electronic apparatus; and
a mover configured to move the electronic apparatus,
wherein, when executed by the at least one processor, the at least one instruction is further configured to control at least one of the driver and the mover such that the projector projects the second image onto the obtained second projection region.

3. The electronic apparatus as claimed in claim 2, wherein the first position information comprises a first position of a counterpart corresponding to the external apparatus in an external space in which the external apparatus is placed, and
wherein the second position information comprises a second position to which the counterpart moves from the first position.

4. The electronic apparatus as claimed in claim 3, wherein the first image is an image of the counterpart positioned in the first position, the first image being captured by the external apparatus, and
wherein, when executed by the at least one processor, the at least one instruction is further configured to control the projector to project the second image corresponding to an image of the counterpart positioned in the second position onto the second projection region, the second image being captured by the external apparatus.

5. The electronic apparatus as claimed in claim 4, wherein the first image is obtained based on a distance between a region onto which a third image different from the first image and the second image is projected and the first position, and
wherein the second image is obtained based on a distance between a region onto which a fourth image different from the first image and the second image is projected and the second position.

6. The electronic apparatus as claimed in claim 5, wherein the first image is obtained further based on a distance between a user of the electronic apparatus and a position of the first projection region, and
wherein the second image is obtained further based on a distance between the user of the electronic apparatus and a position of the second projection region.

7. The electronic apparatus as claimed in claim 2, further comprising:
at least one sensor,
wherein the memory stores map information corresponding to a space in which the electronic apparatus is placed, and
wherein, when executed by the at least one processor, the at least one instruction is further configured to:
obtain a moving path for reaching a position for projecting the second image onto the second projection region, based on the map information, the first projection region and the second projection region, and
based on identifying an object within a threshold distance from the electronic apparatus through the at least one sensor while the electronic apparatus moves along the moving path, obtain an updated moving path based on the object and the moving path and control the mover to move along the updated moving path such that the projector projects the second image onto the second projection region.

8. The electronic apparatus as claimed in claim 1, further comprising:
at least one sensor,
wherein, when executed by the at least one processor, the at least one instruction is further configured to:
obtain a plurality of projection regions based on sensing data obtained from the at least one sensor;
control the projector to project the first image onto the first projection region included in the plurality of projection regions; and
obtain the second projection region included in the plurality of projection regions.

9. The electronic apparatus as claimed in claim 8, wherein, when executed by the at least one processor, the at least one instruction is further configured to:
adjust a size of the first projection region based on a surface area of each of a first projection surface occupied by the plurality of projection regions and a second projection surface corresponding to an external space in which the external apparatus is placed; and
adjust a size of the second projection region based on the surface area of each of the first projection surface and the second projection surface.

10. The electronic apparatus as claimed in claim 3, wherein the memory stores a software model configured to predict a current position of the counterpart corresponding to the second position, based on the first position and the second position, and
wherein, when executed by the at least one processor, the at least one instruction is further configured to:
obtain a current position of the counterpart through the software model, based on the second position information; and
obtain the second projection region corresponding to the obtained current position of the counterpart.

11. A control method of an electronic apparatus, the method comprising:
receiving first position information obtained by an external apparatus;
projecting a first image onto a first projection region obtained based on the first position information;
receiving second position information different from the first position information while the first image is projected onto the first projection region;
obtaining a second projection region different from the first projection region based on the second position information; and
projecting a second image onto the second projection region.

12. The method as claimed in claim 11, further comprising:
adjusting, by a driver, a projection direction of the electronic apparatus; and
moving, by a mover, the electronic apparatus,
controlling at least one of the driver and the mover to project the second image onto the second projection region.

13. The method as claimed in claim 12, wherein the first position information comprises a first position of a counterpart corresponding to the external apparatus in an external space in which the external apparatus is placed, and
wherein the second position information comprises a second position to which the counterpart moves from the first position.

14. The method as claimed in claim 13, wherein the first image is an image of the counterpart positioned in the first position, the first image being captured by the external apparatus, and
wherein the projecting the second image comprises projecting the second image corresponding to an image of the counterpart positioned in the second position onto the obtained second projection region, the second image being captured by the external apparatus.

15. The method as claimed in claim 14, wherein the first image is obtained an based on a distance between a region onto which a third image different from the first image and the second image is projected and the first position, and
wherein the second image is obtained based on a distance between a region onto which a fourth image different from the first image and the second image is projected and the second position.
